(19) United States
(12) Patent Application Publication
(10) Pub. No.: US 2014/0148111 A1
(43) Pub. Date: May 29, 2014

(54) ELECTRONIC DEVICE AND METHOD FOR AVOIDING RF INTERFERENCE

(71) Applicant: HON HAI PRECISION INDUSTRY CO., LTD., New Taipei (TW)

(72) Inventor: YU-TUNG YU, New Taipei (TW)

(73) Assignee: HON HAI PRECISION INDUSTRY CO., LTD., New Taipei (TW)

(21) Appl. No.: 13/961,913

(22) Filed: Aug. 8, 2013

(30) Foreign Application Priority Data
Nov. 26, 2012 (TW) 101144235

(51) Int. Cl. H04B 1/10

(52) U.S. Cl. CPC H04B 1/10
USPC 455/192.2

(57) ABSTRACT

An electronic device which is capable of adjusting the working frequencies of electronic components of a device so as to avoid interference with a received RF signal within a particular range. The electronic device includes a detecting signal and a processor. The detecting unit detects whether a working frequency of an electronic component of the electronic device falls within the predetermined frequency range of the received RF signal. The processor adjusts the working frequency of the electronic component to prevent the received RF signal from being interfered if the working frequency of the electronic component falls with the predetermined frequency range. A method for avoiding RF interference is also provided.

### BACKGROUND

1. Technical Field

The present disclosure relates to an electronic device and method for avoiding Radio Frequency (RF) interference.

2. Description of Related Art

RF receiving devices, such as televisions, have a receiving unit for receiving RF signals, such as channel signals, and each RF signal has a predetermined frequency range. The RF receiving device further includes other electronic components, such as double data rate synchronous dynamic random-access memory (DDR SDRAM), and the electronic components of the RF receiving signal generally have their own working frequencies. However, when the working frequency of an electronic component falls within some of the predetermined channel frequency range, the channel signals will suffer interference.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an electronic device in accordance with an embodiment.

FIG. 2 is a flowchart of a method for avoiding RF interference in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

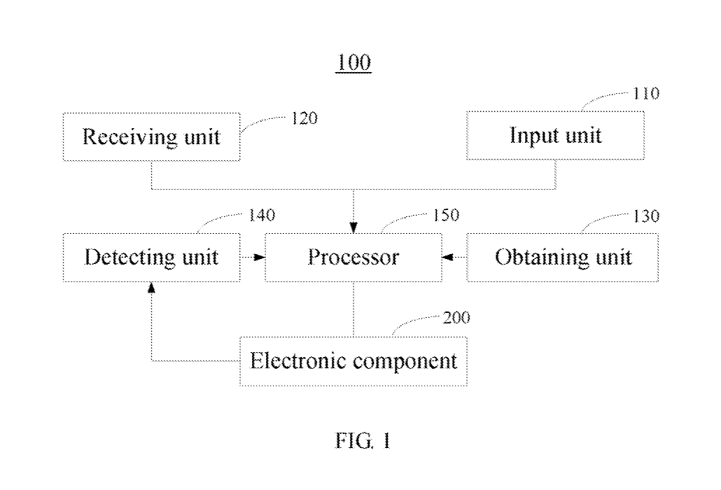

Referring to FIG. 1, an electronic device 100 capable of receiving an Radio Frequency (RF) signal having a predetermined frequency range is provided. When an RF signal having the predetermined frequency range is received, and a working frequency of one of electronic components of the electronic device 100 is detected to fall within the same predetermined frequency range, the electronic device 100 is capable of adjusting the working frequency of the electronic component to be outside the predetermined frequency range, to avoid signal interference.

The electronic device 100 includes an input unit 110, a receiving unit 120, an obtaining unit 130, a detecting unit 140 and a processor 150. The electronic device 100 further includes double data rate synchronous dynamic random-access memory (DDR SDRAM, not shown), and other electronic components. The electronic device 100 in the embodiment is a television.

The input unit 110 generates signals for activating the electronic device 100 to receive an RF signal in response to user operations. In the embodiment, the input unit 110 generates a signal in response to user's operation for selecting a desired channel, to activate the electronic device 100 to receive a channel signal. The input unit 110 can be a plurality of keys and/or buttons, or a touch panel mounted on the electronic device 100, and can also be a remote device for remotely controlling the electronic device 100.

The receiving unit 120 receives an RF signal in response to the signals generated by the input unit 110. The RF signals which are to be received have a predetermined frequency range.

The obtaining unit 130 obtains the predetermined frequency range, for example, between f1 and f2 of the received RF signal, wherein f1 is the minimum and f2 is the maximum, f2 being greater than f1. The obtaining unit 130 in the embodiment further obtains the median f0 of the predetermined frequency range according to the obtained f1 and f2. In the embodiment, the median f0=f1+μ or f2−μ, wherein μ is calculated by the equation: μ=(f2−f1)/2. When the predetermined frequency range of the received RF signal is between 595 MHz and 605 MHz, then f1 is 595 MHz, and f2 is 605 MHz. Thus, μ=5, and the median f0 is 600 MHz by adding μ to f1 or by deducting μ from f2.

The detecting unit 140 detects whether a working frequency of an electronic component (for example, the DDR SDRAM) of the electronic device 100 falls within the predetermined frequency range, and generates a detecting signal if the working frequency of an electronic component of the electronic device 100 falls within the predetermined frequency range. For example, if the working frequency of an electronic component of the electronic device 100 is 597 MHz, the working frequency is detected to be within the predetermined frequency range between 595 MHz and 605 MHz of the received RF signal.

The processor 150 adjusts the working frequency of the electronic component to avoid signal interference in response to the detecting signal. In the embodiment, the processor 150 adjusts the frequency of the electronic component to be outside of the predetermined frequency of the received RF signal. In detail, when the detecting signal is received, the processor 150 determines whether the working frequency f3 of the electronic component is greater than the obtained median f0 of the predetermined frequency range of the received RF signal; if the working frequency f3 is not greater than the obtained median f0, the working frequency f3 is adjusted to be less than the minimum f1. If the working frequency f3 is determined to be greater than the obtained median f0, the working frequency f3 is adjusted to be greater than the maximum f2. As a result, the working frequency of the electronic component is adjusted to be outside of the predetermined frequency of the received RF signal, and the received RF is prevented from being interfered with.

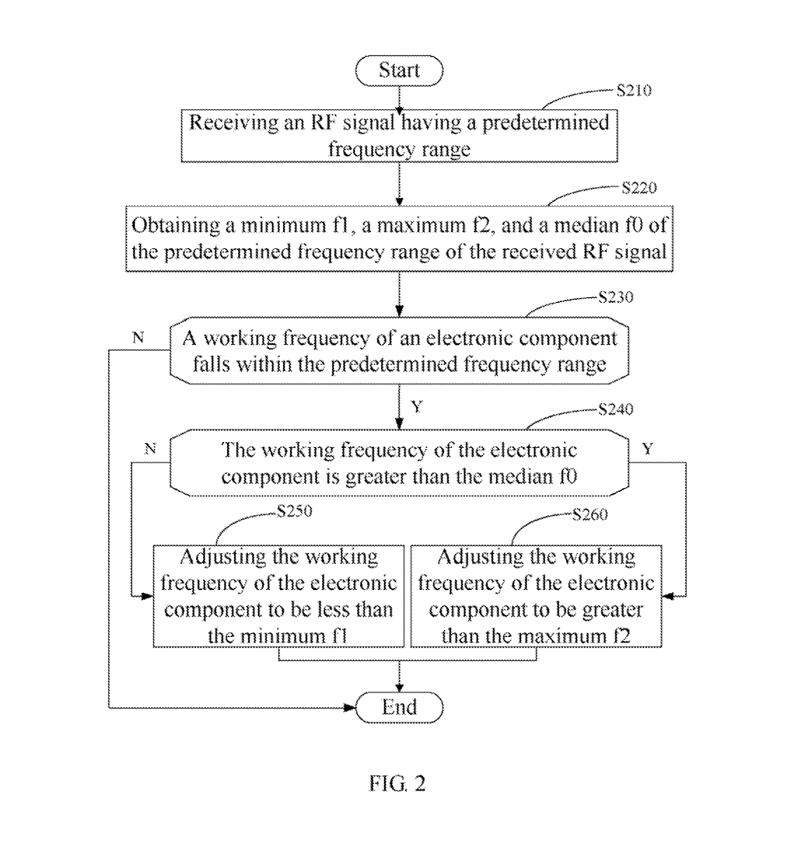

Referring to FIG. 2, a method for avoiding RF interference is provided. The method is applied in the electronic device 100. The electronic device 100 is capable of receiving an RF signal having a predetermined frequency range between f1 and f2. The method includes the following steps:

In step S210, the receiving unit 120 receives an RF signal which is within a predetermined frequency range between f1 and f2 in response to user's operation. In the embodiment, the receiving unit 120 receives a channel signal in response to user's operation of selecting a desired channel.

In step S220, the obtaining unit 130 obtains the minimum f1, the maximum f2, and the median f0 of the predetermined frequency range of the received RF signal.

In step S230, the detecting unit 140 detects whether a working frequency of an electronic component of the electronic device 100 falls within the predetermined frequency range between f1 and f2 of the received RF signal. If yes, the procedure goes to step S240. If no, the procedure ends.

In step S240, the processor 140 determines whether the working frequency of the electronic component is greater than the median f0 of the predetermined frequency range between f1 and f2 of the received RF signal. If yes, the procedure goes to step S250. If no, the procedure goes to step S260.

In step S250, the processor 140 adjusts the working frequency f3 of the electronic component to be less than the minimum f1.

In step S260, the processor 140 adjusts the working frequency f3 of the electronic component to be greater than the maximum f2.

Although information as to, and advantages of, the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. An electronic device capable of receiving an Radio Frequency (RF) signal having a predetermined frequency range, comprising;
a detecting signal to detect whether a working frequency of an electronic component of the electronic device falls within the predetermined frequency range of the received RF signal; and
a processor to adjust the working frequency of the electronic component to prevent the received RF signal from being interfered with if the working frequency of the electronic component falls within the predetermined frequency range.

2. The electronic device of claim 1, wherein the processor adjusts the working frequency of the electronic component to be outside of the predetermined frequency range of the received RF signal to avoid signal interference if the working frequency of the electronic component falls within the predetermined frequency range.

3. The electronic device of claim 2, further comprising an obtaining unit for obtaining a minimum f1, a maximum f2, and a median f0 of the predetermined frequency range of the received RF signal.

4. The electronic device of claim 3, wherein the processor further determines whether the working frequency of the electronic component is greater than the media f0, and adjusts the working frequency of the electronic component to be less than the minimum f1 if the working frequency of the electronic component is not greater than the media f0.

5. The electronic device of claim 1, wherein the processor adjusts the working frequency of the electronic component to be greater than the maximum f2 if the working frequency of the electronic component is greater than the media f0.

6. The electronic device of claim 1, further comprising an input unit and a receiving unit, wherein the input unit generates signals in response to user's operation for receiving a desired RF signal, and the receiving unit receives the desired signal in response to the signals generated by the input unit.

7. A method for avoiding RF interference applied in an electronic device comprising at least one electronic component, the method comprising:
receiving an RF signal having a predetermined frequency range;
detecting whether a working frequency of the electronic component falls within the predetermined frequency range of the received RF signal; and
adjusting the working frequency of the electronic component to prevent the received RF signal from being interfered with if the working frequency of the electronic component falls within the predetermined frequency range.

8. The method according to claim 7, wherein the working frequency of the electronic component to is adjusted to be outside of the predetermined frequency range of the received RF signal to prevent the received RF signal from being interfered if the working frequency of an electronic component falls within the predetermined frequency range.

9. The method according to claim 8, further comprising:
obtaining a minimum f1, a maximum f2, and a median f0 of the predetermined frequency range of the received RF signal.

10. The method of claim 9, further comprising:
determining whether the working frequency of the electronic component is greater than the media f0;
adjusting the working frequency of the electronic component to be less than the minimum f1 if the working frequency of the electronic component is not greater than the media f0; and
adjusting the working frequency of the electronic component to be greater than the maximum f2 if the working frequency of the electronic component is greater than the media f0.
